(19) United States
(12) Patent Application Publication
(10) Pub. No.: US 2014/0045005 A1
(43) Pub. Date: Feb. 13, 2014

(54) lithium-ion rechargeable battery and method for manufacturing same

(71) Applicants: Bernd Schumann, Rutesheim (DE); Niluefer Baba, Stuttgart (DE)

(72) Inventors: Bernd Schumann, Rutesheim (DE); Niluefer Baba, Stuttgart (DE)

(21) Appl. No.: 13/985,494

(22) PCT Filed: Dec. 16, 2011
(86) PCT No.: PCT/EP2011/073013

§ 371 Date: Oct. 22, 2013

(30) Foreign Application Priority Data
Feb. 15, 2011 (DE) 102011004092.7
Mar. 17, 2011 (DE) 102011005681.5

(51) Int. Cl. H01M 10/04

(52) U.S. Cl. CPC H01M 10/0468; H01M 10/049
USPC 429/61; 429/186; 29/623.1

(57) ABSTRACT

A lithium-ion rechargeable battery and to a method for arranging a pack or stack of a lithium-ion rechargeable battery in a housing. The lithium-ion rechargeable battery having a housing and a pack or stack which is situated in the housing, the pack or stack being essentially composed of at least one cathode, at least one anode, at least one separator and at least one non-aqueous electrolyte which is situated between the cathode and the anode, the cathode, the anode, the separator and the at least one electrolyte which is situated between the cathode and the anode being arranged in layers, which is characterized in that the rechargeable battery has a spring element, whose spring force presses the cathode, the anode, the separator and the electrolyte against one another at least in subareas of the rechargeable battery during the normal operating state.

### FIELD OF THE INVENTION

The present invention relates to a lithium-ion rechargeable battery and to a method for arranging a pack or stack of a lithium-ion rechargeable battery in a housing. The present invention relates, in particular, to a lithium-ion rechargeable battery which has a housing and a pack or stack which is situated in the housing, the pack or stack being essentially composed of at least one cathode, at least one anode, at least one separator and at least one non-aqueous electrolyte which is situated between the cathode and the anode, the cathode, the anode, the separator and the at least one electrolyte which is situated between the cathode and the anode being arranged in layers, which is characterized in that the rechargeable battery has a spring element, whose spring force presses the cathode, the anode, the separator and the electrolyte against one another at least in subareas of the rechargeable battery during the normal operating state.

### BACKGROUND INFORMATION

Lithium-ion batteries or rechargeable batteries are used today in a variety of products as energy storage devices. The use of such energy storage devices is believed to be understood, for example, in the area of portable computer systems or telecommunication. Their use as drive batteries in motor vehicles is also discussed intensively in the automotive industry. The safety of lithium-ion rechargeable batteries, in particular in the automotive industry, but also in other areas of application, is of central significance. Due to events causing damage, which have caught the eye of the media, e.g., the burn-out of laptop rechargeable batteries, the issue of safety in lithium-ion rechargeable batteries is a critical factor for the mass application of this technology in other areas of technology as well. A thermal runaway of lithium-ion cells must be prevented in practical use. Present and future energy storage devices using lithium-ion technology are already equipped with a variety of safety mechanisms. Among other things, safety valves are provided, which allow for the discharge of overpressure to the outside in the case of overpressure in the cell. These valves may be configured, for example, as a bursting disk or a pressure release valve. While in the area of portable computer systems or telecommunication rechargeable batteries are formed using only one or a few connected lithium-ion cells, considerably more cells must be integrated in areas which require higher currents, voltages and/or electrical charges. For example, applications within the automotive industry require several hundred lithium-ion cells to be integrated into a battery, which then form a correspondingly powerful rechargeable battery. In this case, supplementary safety measures are necessary to adapt and improve safety concepts for such use.

### SUMMARY OF THE INVENTION

An object of the present invention is to provide a lithium-ion rechargeable battery, which has, in particular, improved protection in the event of thermal overload of the rechargeable battery. In addition, the object of the present invention is to provide a method for manufacturing such an improved rechargeable battery.

The object may be achieved with regard to the battery by the use of a lithium-ion rechargeable battery, which has a housing and a pack or stack which is situated in the housing, the pack or stack being essentially composed of at least one cathode, at least one anode, at least one separator and at least one non-aqueous electrolyte which is situated between the cathode and the anode, the cathode, the anode, the separator and the at least one electrolyte which is situated between the cathode and the anode being arranged in layers, which is characterized in that the rechargeable battery has a spring element, whose spring force presses the cathode, the anode, the separator and the electrolyte against one another at least in subareas of the rechargeable battery during the normal operating state.

Due to the embodiment of a lithium-ion rechargeable battery according to the present invention, a delamination of the pack or stack may be counteracted. The spring element provides for a uniform pressing force of the individual components of the pack (cathode, anode, separator and electrolyte). The spring element simultaneously allows for a volume expansion of the pack or stack, as customary heating or electrochemical reactions may occur during operation of the rechargeable battery. A delamination of the pack or stack via volume contraction after cooling down or a change in the state of charge is counteracted by the spring force of the spring element. The spring element may be configured in such a way that during normal operation of the cell or the rechargeable battery, a uniform pressing force is applied to the components of the rechargeable battery. Thereby, a premature aging of the rechargeable battery may be avoided.

In one embodiment of the lithium-ion rechargeable battery according to the present invention, the spring element is supported against the housing. Thereby, the cell may have a compact configuration and the spring element is given sufficient support to exert the spring force.

In one additional embodiment of the rechargeable battery according to the present invention, the spring element is integrally supported against the housing via a predetermined breaking point. The predetermined breaking point may open the integral joint between the housing and the spring element when a defined force and/or temperature is/are exceeded and the spring force acting upon the pack or stack by the spring element is released.

By attaining a critical operating state, a targeted delamination of the pack or stack may take place, thereby making the switching off of the individual cell possible. In particular, if a short circuit of the pack or stack causes gas pressure, for example due to thermal or chemical decomposition of the electrolyte, an expansion of the pack or stack may take place if the defined holding forces of the integral joint of the predetermined breaking point are exceeded between the spring element and the housing. Thereby, an improved cooling of the cell of the rechargeable battery during a critical operating state may be reached, on the one hand; on the other hand, the gases which have possibly formed may escape. It has been shown that during a thermal burn-out of a lithium-ion rechargeable battery, gasses which form may also participate in further chemical reactions, which may result in an additional increase of the gas pressure within the cell of the rechargeable battery.

Adiabatic calorimeter analyses on standard electrolytes have shown that a significant proportion of the total pressure increase during thermal runaway of a rechargeable battery cell is to be attributed to these electrolyte reactions. Due to the escape of the reaction gas, which is made possible according to the present invention, a further increase of the gas pressure from an additional reaction of these reaction gases is prevented. A thermal runaway of rechargeable battery cells at reaching a critical operating state may thus be reduced or even prevented. Thereby, the safety of the rechargeable battery is considerably increased.

In one further embodiment of the rechargeable battery according to the present invention, the spring element is an integral part of the housing. For example, a spring or wave-shaped section of the housing may be formed so that the spring force is uniformly applied to the pack or stack over the entire housing. This allows for an even more compact configuration to be achieved. In one further embodiment of the present invention, the housing is wave-shaped overall and may, in its entirety, serve as the spring element, which, on the one hand, has an adequate spring force for pressing on the individual components of the pack or stack and, on the other hand, has an adequate elasticity for the admission of the volume expansion caused by the electrochemical reaction or heating of the stack or pack.

In one further embodiment of the present invention, the rechargeable battery has at least one stack, an upper spring element and a lower spring element, which are fixable on the housing via an integrally joined predetermined breaking point, the integral joint between the housing and the spring element at the predetermined breaking point being detachable when a defined force and/or temperature is/are exceeded. Thereby, an optimized adaptation of the idea according to the present invention to a rechargeable battery cell configured as a stack is achieved.

In one further embodiment of the present invention, the stack has a number of layers, which are, among each other, connectable to the spring element, the spring force of the spring element essentially counteracting the spring force of the upper and lower spring elements. When the predetermined breaking force of the predetermined breaking point between the spring element and the housing is/are exceeded, the spring force of the spring element which holds the layers together acts in such a way that the layers are pulled apart. This improves the heat dissipation between the layers, which allows for a quicker cooling of the layers to a subcritical temperature.

With regard to the method, the object of the present invention is achieved via a method for arranging a pack or stack of a lithium-ion rechargeable battery in a housing, the pack or stack being essentially composed of at least one cathode, at least one anode, at least one separator and at least one non-aqueous electrolyte which is situated between the cathode and the anode, the cathode, the anode, the separator and the at least one electrolyte which is situated between the cathode and the anode being arranged in layers, which is characterized in that the cathode, the anode, the separator and the electrolyte are pressed against one another at least in subareas of the pack or stack with the aid of a spring element during the normal operating state of the rechargeable battery.

In one embodiment of the method according to the present invention, the spring element is integrally supported via a predetermined breaking point against the housing, the predetermined breaking point being configured in such a way that it opens the integral joint when a defined force and/or temperature is exceeded and releases the spring force acting upon the pack or stack by the spring element.

The present invention is explained in greater detail in the following based on exemplary embodiments and the figures.

### BRIEF DESCRIPTION OF THE DRAWINGS

FIG. 1 shows a schematic representation of a lithium-ion rechargeable battery according to the present invention.

FIG. 2 shows one embodiment of a rechargeable battery according to the present invention, in which a number of packs are situated next to each other.

FIG. 3 shows one embodiment of a rechargeable battery according to the present invention, in which a number of packs are situated next to each other and the packs are enclosed by a shared housing.

FIG. 4 shows various specific embodiments of rechargeable batteries according to the present invention.

FIG. 5 shows a stack-shaped constructed lithium-ion rechargeable battery according to the present invention during the normal operating state.

FIG. 6 shows the lithium-ion battery according to FIG. 5 after reaching a critical operating state.

### DETAILED DESCRIPTION

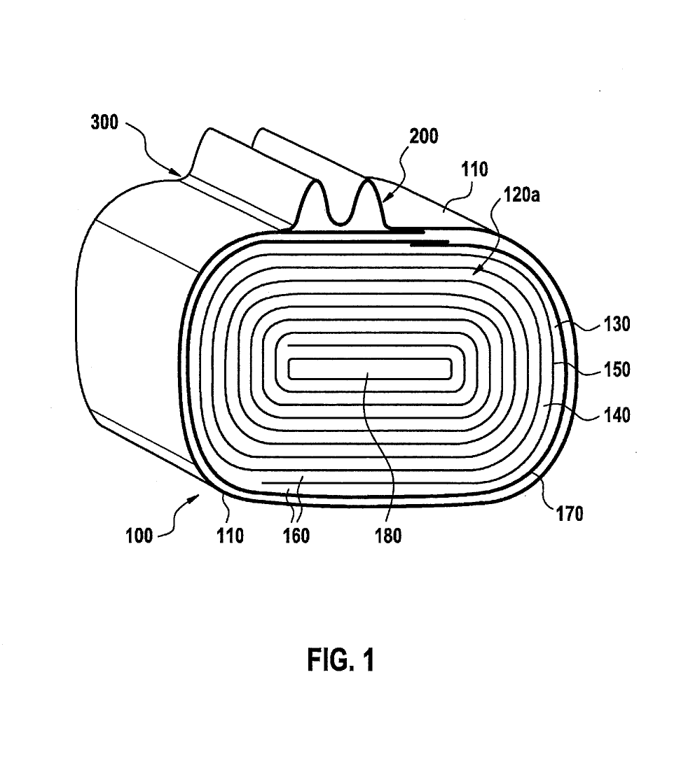

FIG. 1 shows a schematic representation of a lithium-ion rechargeable battery 100 according to the present invention having a housing 110 and a pack 120a which is situated in housing 110. Pack 120a is essentially composed of at least one cathode 130, at least one anode 140, at least one separator 150 and at least one non-aqueous electrolyte 160, which is situated between cathode 130 and anode 140, which are wound around a cell pin 180 situated in the center of pack 120a, which may also be configured as a conductor 180. An additional sliding layer 170 is situated between pack 120a and housing 110, which is responsible for minimizing the friction at the inner wall of housing 110 and pack 120a. Sliding layer 170 may, for example, be made of plastic foil. Cathode 130, anode 140, separator 150, and the electrolyte which is situated between cathode 130 and anode 140 are arranged in layers. Rechargeable battery 100 has a spring element 200 whose spring force presses cathode 130, anode 140, separator 150 and the electrolyte 160 against one another at least in subareas of the rechargeable battery 100 during the normal operating state. Spring element 200 is connected to the housing in such a way that housing 110 encloses pack 120a in the form of a metal clamp, housing 110 being not only configured as an enclosure but also as the housing for the rechargeable battery or the cell; in the latter two cases, the base and the cover must be configured to be appropriately elastic or resilient in order to ensure the tightness of the housing of the rechargeable battery or the cell. This enclosure exerts a certain amount of pressure on pack 120a, which supports the function of good contact of the individual layers 130, 140, 150, 160 of pack 120a. Similarly, due to the elastically resilient enclosure, pack 120a may, according to its electrochemical function, expand and contract as it corresponds to the dimension changes of the discharging or charged cell, without incurring unplanned forces or forces of inappropriate magnitude, which would expose pack 120a locally to an increased force and/or mechanical stress in the composite view.

Spring element 200 is supported against housing 110. This support may be effected via a predetermined breaking point 300 which is configured as an integral joint of spring element 200 to housing 110. The predetermined breaking point 300 is configured in such a way that the integral joint between housing 110 and spring element 200 is opened when a defined force and/or temperature is exceeded, whereby the spring force acting upon pack 120a by spring element 200 is released. With regard to the integral joint between spring element 200 and housing 110, for example, a temperature solder or a thermal melting contact is suitable, which breaks open when a certain temperature as well as a certain force are exceeded and may thus loosen the integral joint. In a safety-critical state of rechargeable battery 100, due to the occurring high temperature or force, the contact of spring element 200 and housing 110 is loosened. Spring element 200 relaxes. The relaxation of spring element 200 leads at least to a partial separation of pack 120a, so that the individual layers 130, 140, 150, 160 detach from each other. This in turn leads to a more rapid cooling of pack 120a and thus to the transfer of the cell into a safe final state. Reaction gases or electrolyte vapors may escape more easily in this way, making them unavailable for an additional reaction.

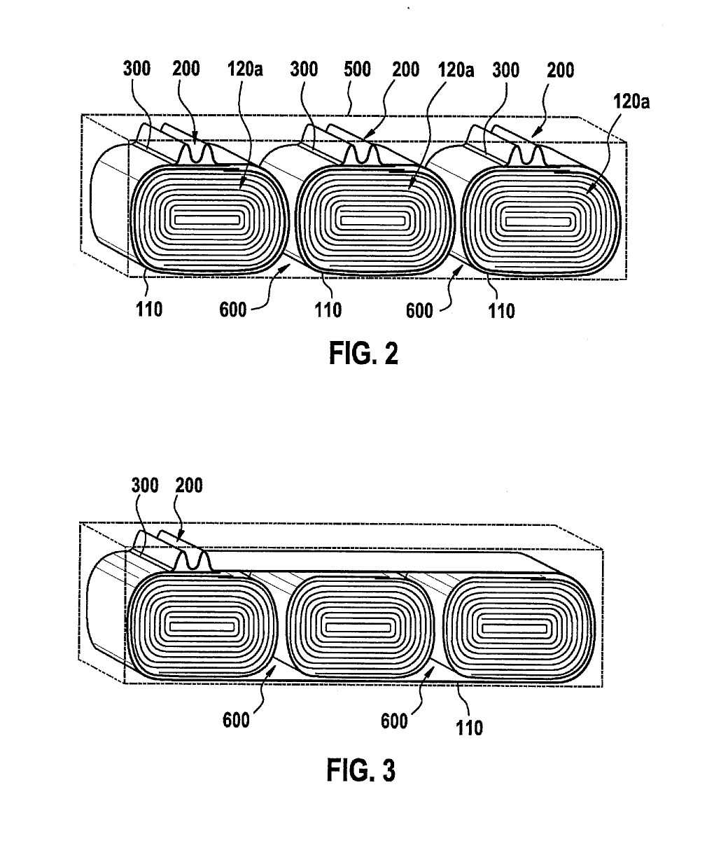

FIG. 2 shows a lithium-ion rechargeable battery according to the present invention, in which a number of packs 120a are housed in a shared housing 500. The individual packs 120a correspond in structure to the packs shown in FIG. 1. Packs 120a may be situated in shared housing 500 in such a way that there is sufficient distance 600 between them, into which the individual packs 120a may expand when critical operating parameters are exceeded and predetermined breaking point 300 is triggered.

FIG. 3 shows an embodiment of a lithium-ion rechargeable battery in which a number of individual packs 120a are enclosed by a shared housing 110. Housing 110 is connected to a shared spring element 200, which is, in the manner described above, integrally joined to housing 110. When critical operating parameters are exceeded and predetermined breaking point 300 is triggered, combined packs 120a expand in shared housing 110 and transfer the cell composite into a safe final state.

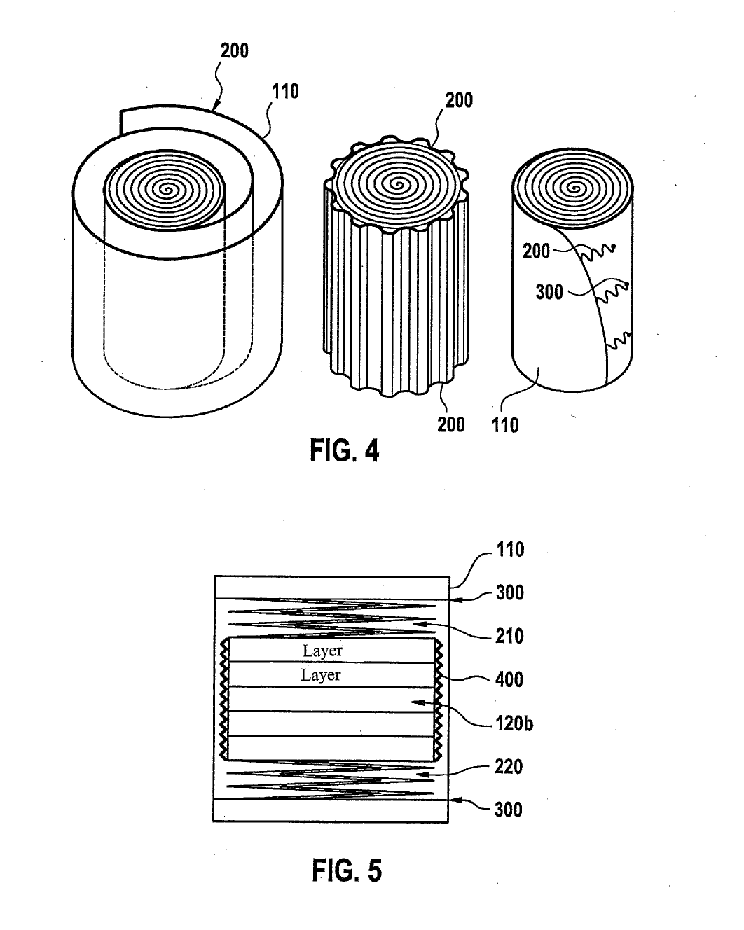

FIG. 4 shows different embodiments of the rechargeable battery according to the present invention. The drawing on the left in FIG. 4 shows a housing 110, which is spiral-shaped and consequently functions as spring element 200. Spring element 200 is therefore an integral part of housing 110 of the shown specific embodiment. The center drawing in FIG. 4 also shows a specific embodiment of the rechargeable battery according to the present invention, in which spring elements 200 are integral parts of housing 110, which is presently configured as a rechargeable battery or cell housing and which does not have a cover for the sake of clarity. The spring elements are configured as wave-shaped bulges in housing 110 via which housing 110 may be correspondingly expanded or contracted. Due to the number of spring elements 200 formed by the wave-shaped bulges and the possible summation of the spring forces via this arrangement, the spring force of the individual elements may be minimized. An even distribution of the spring force over the entire housing radius is simultaneously achieved. In the drawing on the right of FIG. 4, one additional specific embodiment of the rechargeable battery according to the present invention is shown, in which spring elements 200 are connected to the housing via predetermined breaking points 300 configured as soldering points.

FIG. 5 shows an embodiment of a rechargeable battery according to the present invention having cell components combined in a stack 120b. During the normal operating state, an upper spring element 210 and a lower spring element 220 act upon stack 120b. Spring elements 210, 220 are supported, via predetermined breaking points 300, against housing 110. The individual layers of stack 120b are connected to one another by a further spring element 400 serving as a connecting element. The spring force of spring element 400 counteracts the spring force of spring elements 210, 220. During normal operation, the spring force of spring elements 210, 220 provides for a uniform pressing force of the layers of stack 120b.

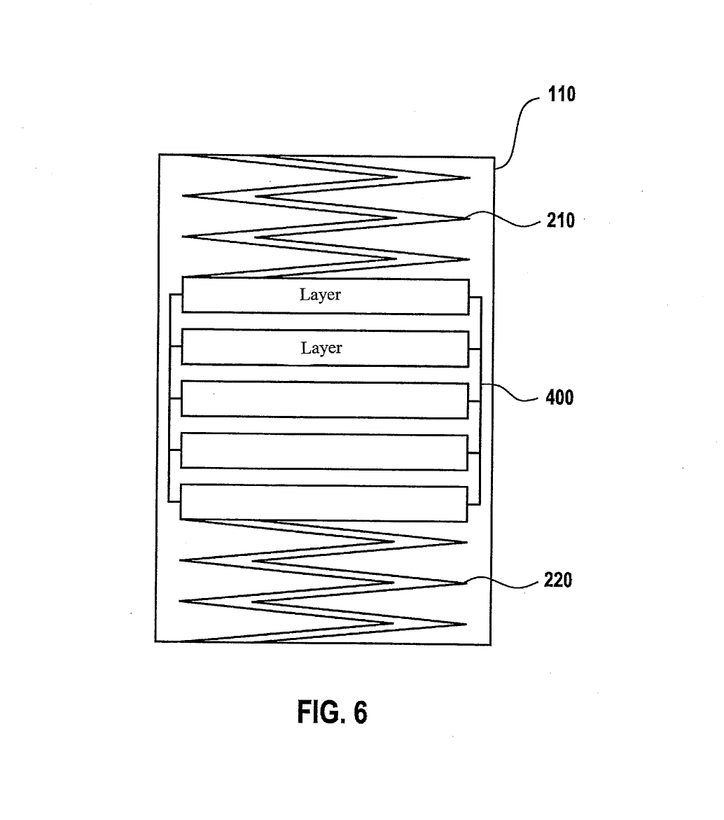

FIG. 6 shows the specific embodiment of the rechargeable battery according to the present invention shown in FIG. 5 after it has reached a critical operating state in which the predetermined breaking points 300 have loosened the integral joint between spring elements 210, 220 and housing 110. In this operating state, the spring force of spring element 400 outweighs the spring force of spring elements 210, 220 so that the layers of stack 120b are pulled apart. This enables a quicker cooling of stack 120b and the escapement of gas, whereby the rechargeable battery stack may be transferred into a safe state. The danger of a further thermal runaway thus no longer exists.

1-10. (canceled)

11. A lithium-ion rechargeable battery, comprising:
a housing; and
a pack or a stack situated in the housing, the pack or the stack including at least one cathode, at least one anode, at least one separator and at least one non-aqueous electrolyte which is situated between the cathode and the anode;
wherein the cathode, the anode, the separator and the at least one electrolyte, which is situated between the cathode and the anode, being arranged in layers, and
wherein the rechargeable battery has a spring element having a spring force that presses the cathode, the anode, the separator and the electrolyte against one another at least in subareas of the rechargeable battery during a normal operating state.

12. The lithium-ion rechargeable battery of claim 11, wherein the spring element is supported against the housing.

13. The lithium-ion rechargeable battery of claim 12, wherein the spring element is integrally supported against the housing via a predetermined breaking point.

14. The lithium-ion rechargeable battery of claim 13, wherein the predetermined breaking point, when a defined force and/or temperature is/are exceeded, opens the integral joint between the housing and the spring element and releases the spring force acting upon the pack or the stack by the spring element.

15. The lithium-ion rechargeable battery of claim 11, wherein the spring element is an integral part of the housing.

16. The lithium-ion rechargeable battery of claim 15, wherein the housing has a predetermined breaking point, which, when a defined force and/or temperature is/are exceeded, opens the housing and releases the spring force acting upon the pack or the stack by the housing.

17. The lithium-ion rechargeable battery of claim 11, wherein there is at least one stack, an upper spring element and a lower spring element, which are fixable onto to the housing via an integrally joined predetermined breaking point, and wherein the integral joint between the housing and the spring element is detachable when at least one of a defined force and a temperature is exceeded.

18. The lithium-ion rechargeable battery of claim 17, wherein the at least one stack has a number of layers, which are, among themselves, connectable to a spring element, the spring force of the spring element essentially acting against the spring force of the upper spring element and the lower spring element.

19. A method for assembling a pack or a stack of a lithium-ion rechargeable battery in a housing, the method comprising:
providing the pack or the stack, which include at least one cathode, at least one anode, at least one separator and at least one non-aqueous electrolyte situated between the cathode and the anode; and
arranging the cathode, the anode, the separator and the at least one electrolyte, which is situated between the cathode and the anode, in layers;
wherein the cathode, the anode, the separator and the electrolyte are pressed against one another at least in subareas of the pack or the stack with the aid of a spring element during a normal operating state of the rechargeable battery.

20. The method of claim 19, wherein the spring element is integrally supported via a predetermined breaking point against the housing, the predetermined breaking point being configured so that, when at least one of a defined force and a temperature is exceeded, it opens the integral joint between the housing and the spring element and releases the spring force acting upon the pack or the stack by the spring element.
